(19) United States
(12) Patent Application Publication
(10) Pub. No.: US 2023/0014370 A1
(43) Pub. Date: Jan. 19, 2023

(54) SAMPLE PROCESSING SYSTEM AND METHOD, CONTROL SYSTEM AND CELL IMAGE ANALYSIS DEVICE

(71) Applicant: Shenzhen Mindray Bio-Medical Electronics Co., Ltd., Shenzhen (CN)

(72) Inventors: Bin JIANG, Shenzhen (CN); Shaokui WENG, Shenzhen (CN); Xuerong LI, Shenzhen (CN)

(21) Appl. No.: 17/953,139

(22) Filed: Sep. 26, 2022

Related U.S. Application Data
(63) Continuation-in-part of application No. PCT/CN2020/082477, filed on Mar. 31, 2020.

(51) Int. Cl. G01N 35/00; G01N 1/28; G01N 35/02

(52) U.S. Cl. CPC G01N 35/00029; G01N 1/2813; G01N 35/02; G01N 2001/002

(57) ABSTRACT

A sample processing system and method, and a control system and a cell image analysis device. A smear preparation device prepares a sample smear, the cell image analysis device performs imaging and analysis on the sample smear, and the sample smear is placed in a first smear storage device. After the sample smear is placed in the first smear storage device, the first smear storage device placed with the sample smear is conveyed by a conveyer from the smear preparation device to the cell image analysis device, and the first smear storage device is conveyed by the conveyer from the cell image analysis device to the smear preparation device, so that automatic cycle conveying of the first smear storage device between the smear preparation device and the cell image analysis device is achieved by the conveyer, and unnecessary human-machine interaction operations are reduced, thereby reducing workload of a user.

### CROSS-REFERENCE TO RELATED APPLICATIONS

This application is a continuation-in-part of International Application No. PCT/CN2020/082477, filed on Mar. 31, 2020, which is incorporated herein by reference in its entirety.

### TECHNICAL FIELD

The disclosure relates to medical device technologies, and in particular, to a sample processing system and method, and a control system and a cell image analysis device.

### BACKGROUND

A smear preparation device can spread a sample to be tested on a slide to form a blood film, and then stain the slide covered with the blood film, so as to prepare a sample smear. A cell image analysis device can image and analyze the sample smear prepared by the smear preparation device. Currently, the sample smear prepared by the smear preparation device may be placed in a smear storage device (for example, a slide basket) by a user, and the user may move the smear storage device to the cell image analysis device. The cell image analysis device can take away sample smears one by one from the smear storage device for imaging and analysis, and then return analyzed sample smears to the smear storage device. The user then takes away the smear storage device placed with the analyzed sample smears.

### SUMMARY

Embodiments of the disclosure provide a sample processing system and method, and a control system and a cell image analysis device, so as to automatically recycle a smear storage device and reduce workload of a user.

According to one aspect, an embodiment of the disclosure provides a sample processing system, including:

a smear preparation device configured to prepare a sample smear of a sample to be tested;

a cell image analysis device configured to image and analyze the sample smear prepared by the smear preparation device;

a first smear storage device configured to place the sample smear prepared by the smear preparation device; and

a transport device connected to the smear preparation device and the cell image analysis device and configured to: after the sample smear prepared by the smear preparation device is placed into the first smear storage device, transport the first smear storage device with the sample smear placed therein from the smear preparation device to the cell image analysis device; and transport the first smear storage device from the cell image analysis device to the smear preparation device.

According to another aspect, an embodiment of the disclosure provides a sample processing method, including:

preparing, by a smear preparation device, a sample smear of a sample to be tested;

after the sample smear prepared by the smear preparation device is placed into a first smear storage device, transporting, by a transport device, the first smear storage device with the sample smear placed therein from the smear preparation device to a cell image analysis device;

extracting, by the cell image analysis device, the sample smear from the first smear storage device for imaging and analysis; and

transporting, by the transport device, the first smear storage device from the cell image analysis device to the smear preparation device.

According to still another aspect, an embodiment of the disclosure provides a control system, including:

a transport device; and

a control device connected to the transport device and configured to:

control the transport device to transport a first smear storage device that is placed with a sample smear from a smear preparation device to a cell image analysis device, wherein the sample smear in the first smear storage device is prepared by the smear preparation device; and

control the transport device to transport the first smear storage device from the cell image analysis device to the smear preparation device.

According to still another aspect, an embodiment of the disclosure provides a sample processing system, including:

a smear preparation device configured to prepare a sample smear of a sample to be tested;

a cell image analysis device configured to image and analyze the sample smear prepared by the smear preparation device;

a first smear storage device configured to place the sample smear prepared by the smear preparation device; and

a transport device configured to: after the sample smear prepared by the smear preparation device is placed into the first smear storage device, transport the first smear storage device with the sample smear placed therein from the smear preparation device to the cell image analysis device; and

a second smear storage device configured to recycle the sample smear that has been imaged and analyzed by the cell image analysis device.

According to still another aspect, an embodiment of the disclosure provides a cell image analysis device, including:

a first sample receiving component configured to receive a sample smear transported from a smear preparation device;

an imaging device configured to image the sample smear to obtain cell images;

an analysis device configured to analyze the cell images;

a second sample receiving component configured to receive the sample smear that has been imaged by the imaging device; and

a transfer component located between the first sample receiving component and the imaging device and between the imaging device and the second sample receiving component, and configured to provide the sample smear in the first sample receiving component to the imaging device and transport the sample smear that has been imaged by the imaging device to the second sample receiving component.

According to the above technical solutions, the smear preparation device prepares the sample smear of the sample to be tested, the cell image analysis device images and analyzes the sample smear prepared by the smear preparation device, the first smear storage device stores the sample smear prepared by the smear preparation device, and the transport device is connected to the smear preparation device and the cell image analysis device. After the sample smear prepared by the smear preparation device is placed into the first smear storage device, the transport device transports the first smear storage device with the sample smear placed therein from the smear preparation device to the cell image analysis device. Besides, the transport device transports the first smear storage device from the cell image analysis device to the smear preparation device. In this way, the transport device automatically and cyclically transports the first smear storage device between the smear preparation device and the cell image analysis device, and the first smear storage device is automatically recycled to the smear preparation device. Therefore, a user is no longer required to manually recycle the first smear storage device, and unnecessary human-computer interaction operations are reduced, thereby reducing workload of the user.

### BRIEF DESCRIPTION OF THE DRAWINGS

In order to more clearly describe the technical solutions in the embodiments of the disclosure or in the prior art, the drawings required for describing the embodiments or the prior art will be briefly described below. The drawings in the following description show some of the embodiments of the disclosure, and those of ordinary skill in the art may still derive other drawings from these drawings without inventive effort.

FIG. 1 is a schematic structural diagram of a sample processing system according to an embodiment of the disclosure;

FIG. 2 is a schematic structural diagram of a cell image analysis device in a sample processing system according to an embodiment of the disclosure;

FIG. 3 is a schematic structural diagram of another cell image analysis device in a sample processing system according to an embodiment of the disclosure;

FIG. 4 is a schematic structural diagram of another sample processing system according to an embodiment of the disclosure;

FIG. 5 to FIG. 13 are schematic structural diagrams of a transport device in a sample processing system according to embodiments of the disclosure;

FIG. 14 is another schematic structural diagram of a transport device in a sample processing system according to an embodiment of the disclosure;

FIG. 15 is a flowchart of a sample processing method according to an embodiment of the disclosure;

FIG. 16 is a flowchart of another sample processing method according to an embodiment of the disclosure;

FIG. 17 is a flowchart of still another sample processing method according to an embodiment of the disclosure;

FIG. 18 is a schematic structural diagram of still another sample processing system according to an embodiment of the disclosure; and

FIG. 19 is a schematic structural diagram of a cell image analysis device according to an embodiment of the disclosure.

### DESCRIPTION OF THE PREFERRED EMBODIMENTS

To make the objectives, technical solutions, and advantages of the disclosure clearer, the disclosure will be described in further detail below with reference to the accompanying drawings. The disclosure shall not be construed as limited to the embodiments provided herein. Instead, the content recorded in the embodiments of the disclosure renders the disclosure comprehensive and complete, and conveys the concept of the embodiments of the disclosure to those skilled in the art. Therefore, all other embodiments derived by those of ordinary skill in the art without involving any inventive effort shall fall within the scope of protection of the disclosure.

It should be noted that, in the embodiments of the disclosure, the terms “comprise”, “include”, or any other variation thereof are intended to cover a non-exclusive inclusion, such that a method or server including a series of elements includes not only expressly recorded elements, but also other elements not expressly listed, or elements inherent in implementing the method or server. In the absence of more restrictions, an element defined by “including a/an . . . ” does not exclude the presence of a further related element in a method or server that includes the element (for example, a step in the method or a unit in the server; the unit, for example, may be a part of a circuit, a part of a processor, a part of a program or software, or the like).

For example, the sample processing system provided in the embodiments includes a series of devices, but is not limited to the explicitly stated devices. Similarly, the sample processing method provided in the embodiments includes a series of steps, but is not limited to the stated steps. It should be noted that, an “embodiment” is involved in the following description, which describes a subset of all possible embodiments. However, it may be understood that an “embodiment” may be the same subset or different subsets of all possible embodiments, and may be combined with each other in the case of no conflict.

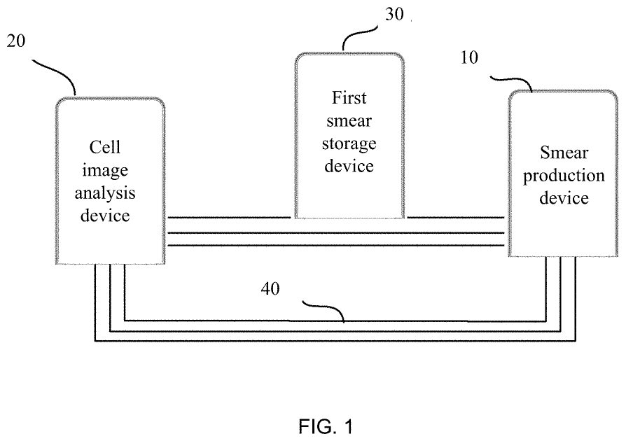

FIG. 1 shows an optional structure of a sample processing system according to an embodiment of the disclosure. The sample processing system may include a smear preparation device 10, a cell image analysis device 20, a first smear storage device 30, and a transport device 40.

The smear preparation device 10 is configured to prepare a sample smear of a sample to be tested, so that specific cells, such as abnormal cells, in the sample to be tested can be analyzed in a targeted manner. The sample smear is also called a substrate on which a specimen is smeared, for example, a glass slide on which a blood sample is evenly smeared and cells in the sample are stained.

In this embodiment, the smear preparation device 10 obtains, through operations such as smearing and staining, the sample smear of the sample to be tested. However, it should be noted herein that, the sample to be tested currently includes at least one of a blood sample and a body fluid sample. Preparation methods for a blood sample and a body fluid sample are different in that: during preparation of a sample smear of a body fluid sample, an area of a specific shape such as a circular area needs to be formed via a slide spinning operation. For this feature of a sample smear of a body fluid sample, the smear preparation device 10 may include a first preparation device (for example, a smearing machine) for smear preparation of a blood sample and a second preparation device (for example, a centrifugal slide spinner) for smear preparation of a body fluid sample. When the smear preparation device obtains a sample to be tested, if the sample to be tested is a blood sample, the sample to be tested is transported to the first preparation device (for example, a smearing machine), or if the sample to be tested is a body fluid sample, the sample to be tested is transported to the second preparation device (for example, a centrifugal slide spinner).

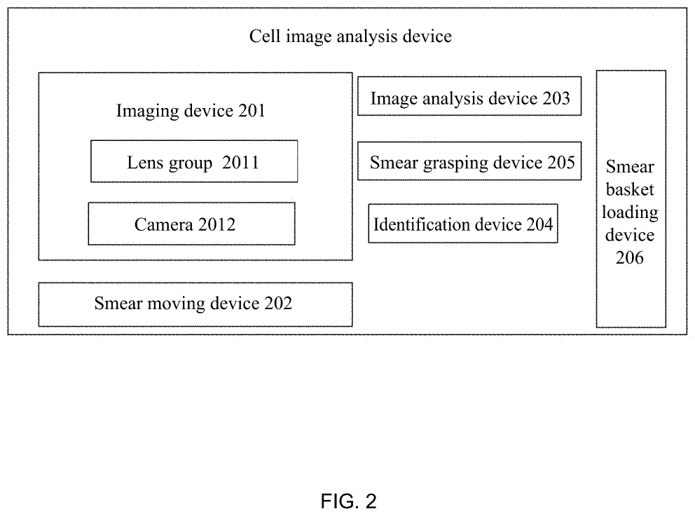

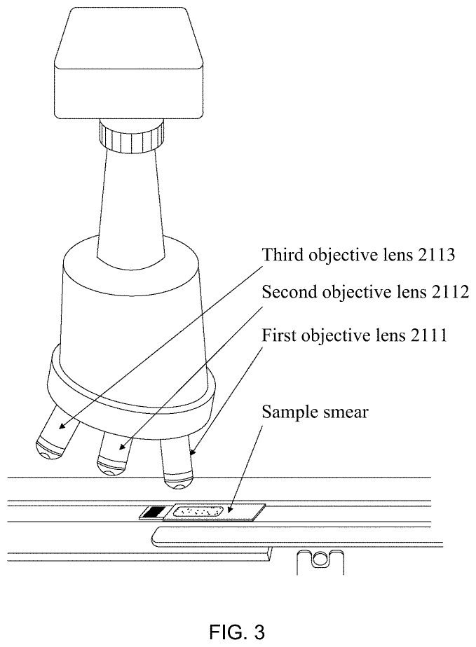

The cell image analysis device 20 is configured to image and analyze the sample smear prepared by the smear preparation device, especially to identify and locate cells in the sample smear by capturing cell images of the sample smear, and then image and analyze the identified and located cells. An optional structure of the cell image analysis device 20 is shown in FIG. 2 and FIG. 3. The cell image analysis device 20 at least includes an imaging device 201, a smear moving device 202, and an image analysis device 203.

The imaging device 201 includes a camera 2012 and a lens group 2011 and is configured to image cells in the sample to be tested on the sample smear. The smear moving device 202 is configured to move the sample smear relative to the imaging device 201, such that the imaging device 201 captures cell images of a specific region of the sample smear. The image analysis device 203 is configured to analyze the cell images of the sample smear.

As shown in FIG. 3, the lens group 2011 may include a first objective lens 2111 and a second objective lens 2112. One of the first objective lens 2111 and the second objective lens 2112 is a low-power objective lens, and the other is a high-power objective lens. For example, the first objective lens 2111 is a low-power objective lens, and the second objective lens 2112 is a high-power objective lens. For example, the first objective lens 2111 may be a 10x objective lens, and the second objective lens 2112 may be a 100x objective lens. The lens group 2011 may further include a third objective lens 2113. Magnification of the third objective lens 2113 is between the magnification of the first objective lens and the magnification of the second objective lens. For example, the third objective lens 2113 may be a 40x objective lens.

The cell image analysis device 20 further includes an identification device 204 and a smear gripping device 205. The identification device 204 is configured to identify sample identification information of the sample smear and obtain at least a sample type of the sample to be tested based on the sample identification information, for example, whether the sample to be tested is a blood sample or a body fluid sample. The smear gripping device 205 is configured to grip the sample smear from the identification device 204 onto the smear moving device 202, so that the smear moving device 202 drives the sample smear to move relative to the imaging device 201.

The first smear storage device 30 is configured to place the sample smear prepared by the smear preparation device. The structure of the first smear storage device 30 is not limited in this embodiment. For example, the first smear storage device 30 may be a smear basket. Correspondingly, the cell image analysis device 20 further includes a smear basket loading device 206 configured to load a smear basket containing the sample smear to be tested. The smear gripping device 205 is further configured to grip the sample smear in the smear basket loaded on the smear basket loading device 206, and move said sample smear to the identification device 204 for sample information identification.

The transport device 40 is connected to the smear preparation device 10 and the cell image analysis device 20 and is configured to: after the sample smear prepared by the smear preparation device 10 is placed into the first smear storage device 30, transport the first smear storage device 30 storing the sample smear from the smear preparation device 10 to the cell image analysis device 20, and transport the first smear storage device 30 from the cell image analysis device 20 to the smear preparation device 10, so that the transport device 40 cyclically transports the first smear storage device 30 between the smear preparation device 10 and the cell image analysis device 20.

In this embodiment, the transport device 40 may be any device that cyclically transports the first smear storage device 30 between the smear preparation device 10 and the cell image analysis device 20. For example, the transport device 40 may be a conveyor device (for example, a conveyor belt), or may be a gripping mechanism. Certainly, the transport device 40 may include a conveyor device and a gripping mechanism, one of the conveyor device and the gripping mechanism is configured to transport the first smear storage device 30 with the sample smear placed therein from the smear preparation device 10 to the cell image analysis device 20, and the other of the conveyor device and the gripping mechanism is configured to transport the first smear storage device 30 from the cell image analysis device 20 to the smear preparation device 10.

If the transport device 40 is a conveyor device, at least one conveyor device may be provided between the smear preparation device 10 and the cell image analysis device 20. For example, one conveyor belt with bidirectional movement may be provided between the smear preparation device 10 and the cell image analysis device 20, such that it can be realized, by bidirectional transport, to transport the first smear storage device from the smear preparation device to the cell image analysis device and from the cell image analysis device to the smear preparation device. Alternatively, one closed conveyor belt with unidirectional movement may be provided, so that the first smear storage device can be cyclically transported between the smear preparation device and the cell image analysis device. Alternatively, one conveyor belt is provided in a transport direction from the smear preparation device 10 to the cell image analysis device 20, and another conveyor belt is provided in a transport direction from the cell image analysis device 20 to the smear preparation device 10, so that the smear preparation device 10 and the cell image analysis device 20 can be arranged freely.

Similarly, if the transport device 40 is a gripping mechanism, at least one gripping mechanism may be provided between the smear preparation device 10 and the cell image analysis device 20. For example, one gripping mechanism is provided between the smear preparation device 10 and the cell image analysis device 20, and cyclically transports the first smear storage device 30 between the smear preparation device 10 and the cell image analysis device 20. Alternatively, one gripping mechanism is provided in a transport direction from the smear preparation device 10 to the cell image analysis device 20, and another gripping mechanism is provided in a transport direction from the cell image analysis device 20 to the smear preparation device 10. Although a number of gripping mechanisms is increased, a running track of the gripping mechanisms is shortened.

It should be noted here that: when the transport device 40 includes a gripping mechanism, the gripping mechanism may not only grip the first smear storage device 30, but may also grip the sample smear stored in the first smear storage device 30 onto the cell image analysis device 20 and/or grip the sample smear prepared by the smear preparation device 10 onto the first smear storage device 30. In this way, the cell image analysis device 20 and/or the smear preparation device 10 does not need to be provided with a mechanism for gripping the sample smear, thereby reducing the size of the cell image analysis device 20 and/or the smear preparation device 10. In addition, in this embodiment, the transport device 40 may further include a plurality of gripping mechanisms, and the plurality of gripping mechanisms simultaneously perform at least one of the following operations: simultaneously gripping a plurality of sample smears onto the first smear storage device 30, simultaneously gripping a plurality of sample smears stored in the first smear storage device 30 onto the cell image analysis device 20, and simultaneously gripping a plurality of first smear storage devices 30.

The transport device 40 may transport the first smear storage device 30 from the cell image analysis device 20 to the smear preparation device 10 on the following occasion: after the cell image analysis device retrieves all sample smears in the first smear storage device 30, the first smear storage device 30 is transported from the cell image analysis device 20 to the smear preparation device 10, that is, after all the sample smears in the first smear storage device 30 are extracted by the cell image analysis device, the first smear storage device 30 is recycled. In this case, whether the cell image analysis device 20 completes imaging of the sample smears is not limited in this embodiment. For example, it is detected in real time whether all sample smears to be tested in the first smear storage device are taken away. When it is detected that the first smear storage device 30 in the cell image analysis device is empty, that is, all the sample smears in the first smear storage device are taken away, recycle of the empty first smear storage device 30 is automatically triggered. In some embodiments, the sample processing system further includes a control device configured to: when it is detected that all sample smears in the first smear storage device transported to the cell image analysis device are taken away, control the transport device to start transport, that is, control the transport device to transport the empty first smear storage device from the cell image analysis device to the smear preparation device. During transporting the first smear storage device by the transport device 40, the first smear storage device 30 transported by the transport device 40 to the cell image analysis device 20 is placed with a sample smear, but for the first smear storage device 30 transported from the cell image analysis device 20 to the smear preparation device 10, the following two cases may be included.

One case is as follows: the first smear storage device transported from the cell image analysis device to the smear preparation device is placed with a sample smear that has been imaged by the cell image analysis device 20. In this case of transporting the first smear storage device 30 to the smear preparation device 10, a user is required to manually take away the sample smear from the first smear storage device 30.

The other case is as follows: the transport device 40 may transport the empty first smear storage device 30 (that is, no sample smear is placed therein) from the cell image analysis device 20 to the smear preparation device 10, so that a user is not required to manually take away the sample smear. The empty first smear storage device 30 may be further configured to place a sample smear prepared by the smear preparation device 10. In addition, during the sample smear passing through the cell image analysis device 20, the cell image analysis device usually smears lens oil on the surface of the sample smear. If the sample smear whose surface is smeared with lens oil is returned to the first smear storage device 30, the first smear storage device 30 will be contaminated. During repeated usage of the first smear storage device 30, the user needs to manually clean the first smear storage device 30. However, if an empty first smear storage device 30 is transported back to the smear preparation device 10 after passing through the cell image analysis device 20, it indicates that the sample smear passing through the cell image analysis device 20 is not returned to the first smear storage device 30 and the first smear storage device 30 will not be contaminated by the sample smear. Therefore, the user does not need to manually clean the first smear storage device 30.

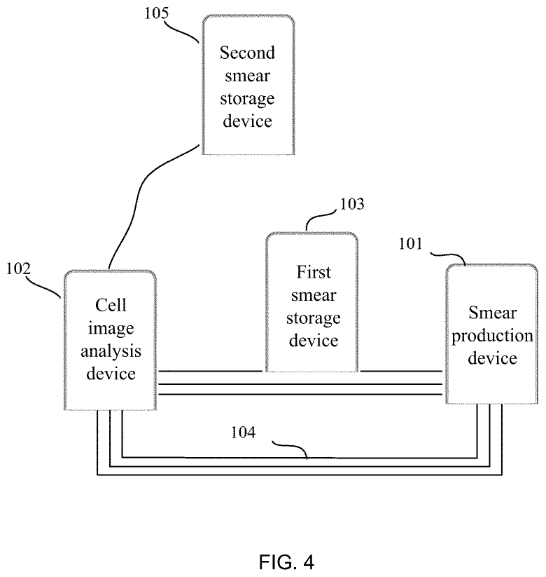

Correspondingly, the sample processing system provided in this embodiment may further include a second smear storage device 50, as shown in FIG. 4. The second smear storage device 50 is configured to recycle the sample smear that has been imaged by the cell image analysis device 20, so that the second smear storage device 50 recycles sample smears, thereby reducing workload of organizing processed sample smears by the user and also avoiding contamination of the first smear storage device 30. The structure of the second smear storage device 50 is not limited in this embodiment. For example, the second smear storage device 50 may be a smear basket. Because a storage space of the second smear storage device 50 is limited, when the storage space of the second smear storage device 50 is full, for example, an entire area for placing sample smears is fully placed with sample smears, an empty second smear storage device 50 may be used. Certainly, the sample smears may be alternatively removed from the second smear storage device 50, for example, the user manually removes the sample smears from the second smear storage device 50, or a gripping mechanism is added to the sample processing system, so as to remove the sample smears from the second smear storage device 50 by the gripping mechanism.

In this embodiment, the second smear storage device 50 may recycle the sample smear that has been imaged by the cell image analysis device 20 by the following manners, but the disclosure is not limited to these manners.

One manner is as follows: The cell image analysis device 20 includes a transport component. The transport component of the cell image analysis device 20 transports the sample smear that has been imaged to the second smear storage device 50. For example, the transport component may be a gripping mechanism, and the gripping mechanism transports the sample smear that has been imaged to the second smear storage device 50. In this way, the sample smear may be recycled by the cell image analysis device 20 itself, so that the structure of the cell image analysis device 20 does not need to be changed and the structure of the transport device 40 can be simplified. Herein, a first transport path for transporting the sample smear that has been imaged to the second smear storage device 50 by the transport component and a second transport path for transporting the first smear storage device 30 between the smear preparation device 10 and the cell image analysis device 20 by the transport device 40 are different from each other and are not overlapped with each other, that is, the first transport path for transporting the sample smear by the transport component and the second transport path for transporting the first smear storage device 30 by the transport device 40 are different from each other and are not overlapped with each other, for example, the first transport path and the second transport path are located on two sides of the cell image analysis device 20. This facilitates the design of the structure, transport actions are less likely to interfere with each other, and the efficiency is improved.

Another manner is as follows: The transport device 40 includes a first transport branch and a second transport branch, the first transport branch is configured to cyclically transport the first smear storage device 30 between the smear preparation device 10 and the cell image analysis device 20, and the second transport branch is configured to transport the sample smear that has been imaged to the second smear storage device 50, so that entire transport of the sample smear is completed by the transport device 40. In this way, the cell image analysis device 20 does not need to recycle the sample smear, so that the cell image analysis device 20 can focus on imaging and analysis. In this embodiment, structures of the first transport branch and the second transport branch may be at least one of a conveyor belt and a gripping mechanism (the gripping mechanism herein does not belong to the cell image analysis device), and reference may be made to the aforesaid description of the transport device 40 for details, which will not be described herein. In particular, the first transport branch and the second transport branch are different from each other and are not overlapped with each other.

For said second smear storage device 50, the second smear storage device 50 may also be provided in the cell image analysis device 20, and the transport component of the cell image analysis device 20 recycles the sample smear imaged by the cell image analysis device 20. However, this increases the size of the cell image analysis device 20.

According to the above technical solutions, the smear preparation device 10 prepares the sample smear of the sample to be tested, the cell image analysis device 20 images and analyzes the sample smear prepared by the smear preparation device 10, the first smear storage device 30 stores the sample smear prepared by the smear preparation device 10, and the transport device 40 is connected to the smear preparation device 10 and the cell image analysis device 20. After the sample smear prepared by the smear preparation device 10 is placed into the first smear storage device 30, the transport device 40 transports the first smear storage device 30 with the sample smear placed therein from the smear preparation device 10 to the cell image analysis device 20. Besides, the transport device 40 transports the first smear storage device 30 from the cell image analysis device 20 to the smear preparation device 10. In this way, the transport device 40 automatically and cyclically transports the first smear storage device 30 between the smear preparation device 10 and the cell image analysis device 20, and the first smear storage device 30 is automatically recycled to the smear preparation device 10. Therefore, a user is no longer required to manually recycle the first smear storage device, and unnecessary human-computer interaction operations are reduced, thereby reducing workload of the user.

The transport device 40 may also transport a first smear storage device 30 for placing a sample smear to the smear preparation device 10. It should be noted that said first smear storage device 30 herein is not the first smear storage device 30 recycled from the cell image analysis device 20, and instead is an empty first smear storage device 30 transported by the transport device 40 to the smear preparation device 10 for the first time. These first smear storage devices 30 are continuously and cyclically transported between the smear preparation device 10 and the cell image analysis device 20 by the transport device 40, to recycle the first smear storage devices 30. Certainly, the first smear storage device 30 may be damaged during usage, and the damaged first smear storage device 30 may be manually removed by the user. Alternatively, an imaging device and a control device are added to the sample processing system, and the imaging device images the first smear storage device 30, to identify whether the first smear storage device 30 is damaged based on an image recognition algorithm, and if yes, the control device instructs the transport device 40 to remove the damaged first smear storage device 30, so that the damaged first smear storage device is no longer used. Alternatively, in the sample processing system, a preset usage time of the first smear storage device 30 is set, and if an actual usage time is longer than the preset usage time, the transport device 40 removes the first smear storage device 30, so that the first smear storage device is no longer used.

When a first smear storage device 30 is removed, a number of first smear storage devices 30 available for the smear preparation device 10 decreases. In this embodiment, the transport device 40 may further replenish a first smear storage device. A specific replenishment process is not described in detail in this embodiment.

The sample smear prepared by the smear preparation device 10 includes at least two types: a sample smear that needs to be imaged and analyzed and a sample smear that does not need to be imaged and analyzed. The smear preparation device 10 is further configured to: if the sample smear needs to be imaged and analyzed, transport, from the smear preparation device 10 to the cell image analysis device 20 by using the transport device 40, the first smear storage device 30 placed with the sample smear that needs to be imaged and analyzed; and transport, away from the smear preparation device 10, the first smear storage device 30 placed with the sample smear that does not need to be imaged and analyzed.

In this case, after preparing sample smears, the smear preparation device 10 needs to store the sample smears differently. For example, the smear preparation device 10 is configured to control a sample smear that needs to be imaged and analyzed and a sample smear that does not need to be imaged and analyzed to be respectively placed in different first smear storage devices. In this way, only all sample smears that need to be imaged and analyzed can reach the cell image analysis device, and sample smears that do not need to be imaged and analyzed are prevented from reaching the cell image analysis device. Compared with transport of all sample smears to the cell image analysis device, the sample smears that need to be imaged and analyzed can reach the cell image analysis device more quickly, and analysis efficiency of the sample smears is improved.

The transport device 40 provided in this embodiment is described below. In this embodiment, the transport device 40 may include a first transport component and a second transport component.

The first transport component is configured to: after the sample smear prepared by the smear preparation device is placed into the first smear storage device, transport the first smear storage device with the sample smear placed therein from the smear preparation device to the cell image analysis device. The second transport component is configured to transport an empty first smear storage device from the cell image analysis device to the first transport component. The first transport component and the second transport component may be conveyor devices or gripping mechanisms. Certainly, the first transport component and the second transport component may include a conveyor device and a gripping mechanism, and reference may be made to the aforesaid description of the transport device 40 for details, which will not be described herein.

In this embodiment, the first transport component and the second transport component may be two components independent of each other, for example, two gripping mechanisms or conveyor belts independent of each other. In this way, when the first transport component transports a first smear storage device 30 to the cell image analysis device 20, the second transport component may also transport an empty first smear storage device 30 to the smear preparation device, thereby reducing the time in which the cell image analysis device 20 and the smear preparation device 10 wait for a first smear storage device 30.

The first transport component and the second transport component may also be a same transport component, for example, the first transport component and the second transport component may be a same gripping mechanism or a conveyor belt with bidirectional movement. In this case, a first smear storage device may be transported to only the cell image analysis device 20 or the smear preparation device 10 at a time, thereby increasing the time for which the cell image analysis device 20 and the smear preparation device 10 wait for a first smear storage device 30. For another example, the first transport component and the second transport component may be a closed conveyor belt with unidirectional movement. In this case, a first smear storage device 30 may be transported to the cell image analysis device 20 and a first smear storage device 30 may be transported to the smear preparation device 10 simultaneously, thereby reducing the time in which the cell image analysis device 20 and the smear preparation device 10 wait for a first smear storage device 30.

Because working efficiency of the smear preparation device 10 is different from that of the cell image analysis device 20, in this embodiment, the transport device 40 may cyclically transport the first smear storage device between at least one smear preparation device 10 and at least one cell image analysis device 20. For example, if the working efficiency of the smear preparation device 10 is higher than that of the cell image analysis device 20, one smear preparation device corresponds to a plurality of cell image analysis devices, that is, the transport device 40 transports the first smear storage device 30 with sample smears prepared by said smear preparation device placed therein, to different cell image analysis devices, and the plurality of cell image analysis devices process the sample smears simultaneously, to improve processing efficiency. Similarly, if the working efficiency of the smear preparation device 10 is lower than that of the cell image analysis device 20, a plurality of smear preparation devices correspond to one cell image analysis device, that is, sample smears in the first smear storage device transported to the cell image analysis device by the transport device 40 are prepared by the plurality of smear preparation devices, to accelerate preparation and processing of the sample smears. Herein, the correspondence between the smear preparation device and the cell image analysis device and quantities of smear preparation devices and cell image analysis devices are not limited in this embodiment.

Because the working efficiency of the smear preparation device 10 is different from that of the cell image analysis device 20, at least one of the first transport component and the second transport component corresponds to a buffer area, and the buffer area is used to buffer the first smear storage device. For example, the buffer area of the first transport component is used to buffer the first smear storage device placed with the sample smear, and the buffer area of the second transport component is used to buffer the empty first smear storage device.

In this embodiment, the transport device 40 includes at least one of a first input buffer area, a first output buffer area, a second input buffer area, and a second output buffer area, wherein

the first input buffer area is configured to buffer the empty first smear storage device 30 that needs to be transported to the smear preparation device 10; the first output buffer area is configured to buffer the first smear storage device 30 placed with the sample smear, that is transported out of the smear preparation device 10; the second input buffer area is configured to buffer the first smear storage device 30 placed with the sample smear, that needs to be transported to the cell image analysis device 20; and the second output buffer area is configured to buffer the empty first smear storage device 30 that needs to be transported to the first input buffer area, so that the first smear storage device 30 can be buffered at each transport stage through the four buffer areas. A relationship among the first input buffer area, the first output buffer area, the second input buffer area, and the second output buffer area is as follows:

The first input buffer area and the second output buffer area are a same buffer area, and/or the first output buffer area and the second input buffer area are a same buffer area, so as to reduce the buffer space in the transport device 40 and reduce the size of the transport device.

The first input buffer area, the first output buffer area, the second input buffer area, and the second output buffer area are buffer areas independent of each other. Although this increases the size of the transport device, more first smear storage devices can be provided for the cell image analysis device 20 and the smear preparation device 10.

The first input buffer area and the first output buffer area may be provided at a same level, and/or the second input buffer area and the second output buffer area may be provided at a same level. In the case of providing at a same level, the first input buffer area may be located before the first output buffer area, and/or the second input buffer area may be located before the second output buffer area. Certainly, the first input buffer area may also be located behind the first output buffer area, and/or the second input buffer area may be located behind the second output buffer area.

The first input buffer area and the first output buffer area are arranged one above another, and/or the second input buffer area and the second output buffer area are arranged one above another, so as to reduce the size of the transport device 40. Correspondingly, the transport device 40 not only has a function of cyclically transporting the first smear storage device between the cell image analysis device and the smear preparation device, but the transport device 40 also has a function of transporting the first smear storage device 30 between the first input buffer area and the first output buffer area and a function of transporting the first smear storage device 30 between the second input buffer area and the second output buffer area. For example, the transport device may be implemented by a gripping mechanism or a mechanism with a lifting function, such as a conveyor belt with a lifting function.

For example, the first output buffer area may be located above the first input buffer area, and correspondingly, the transport device 40 is further configured to transport the empty first smear storage device buffered in the first input buffer area to the first output buffer area, so as to receive the sample smear prepared by the smear preparation device 10, for example, the empty first smear storage device buffered in the first input buffer area is transported to the first output buffer area by using a mechanism with a lifting function in the transport device 40; and/or the second output buffer area may be located below the second input buffer area, and correspondingly, the transport device 40 is further configured to transport the empty first smear storage device 30 in the second input buffer area from the second input buffer area to the second output buffer area, wherein the sample smear in the empty first smear storage device 30 in the second input buffer area is retrieved by the cell image analysis device 20.

The first input buffer area and/or the first output buffer area is/are located in the smear preparation device 10; and/or the second input buffer area and/or the second output buffer area is/are located in the cell image analysis device 20.

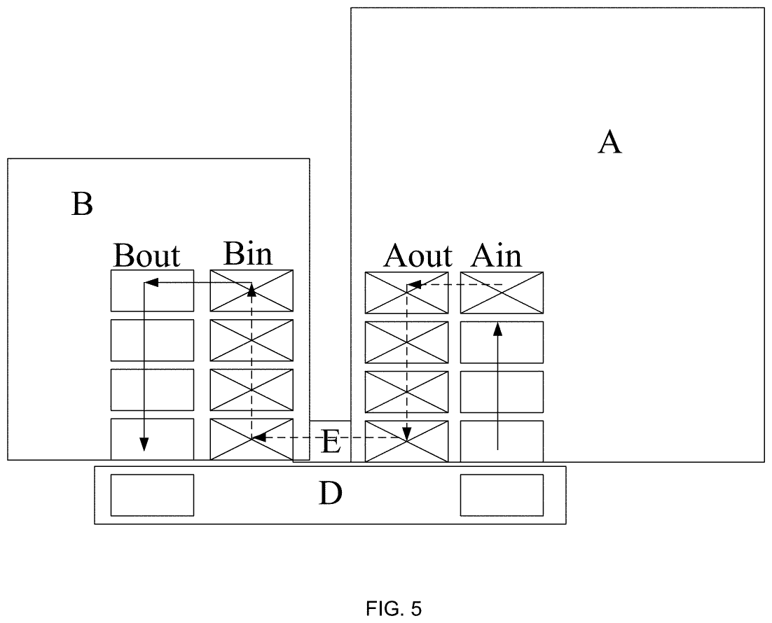

For ease of understanding, the buffer areas in the transport device 40 are described below with reference to accompanying drawings. FIG. 5 to FIG. 13 show forms of the buffer areas and arrangements of the buffer areas included in the transport device 40. In FIG. 5 to FIG. 13, A represents the smear preparation device, B represents the cell image analysis device, Ain represents the first input buffer area, Aout represents the first output buffer area, Bin represents the second input buffer area, Bout represents the second output buffer area, Alift represents transport of the empty first smear storage device buffered in the first input buffer area to the first output buffer area, Blift represents transport of the empty first smear storage device 30 buffered in the second input buffer area from the second input buffer area to the second output buffer area, a rectangle with a cross sign represents the first smear storage device with the sample smear placed therein, a rectangle without a cross sign represents the empty first smear storage device, arrows in FIG. 5 to FIG. 13 represent transport directions of the first smear storage device, solid arrows represent transport directions of the empty first smear storage device, and dashed arrows represent transport directions of the first smear storage device with the sample smear placed therein.

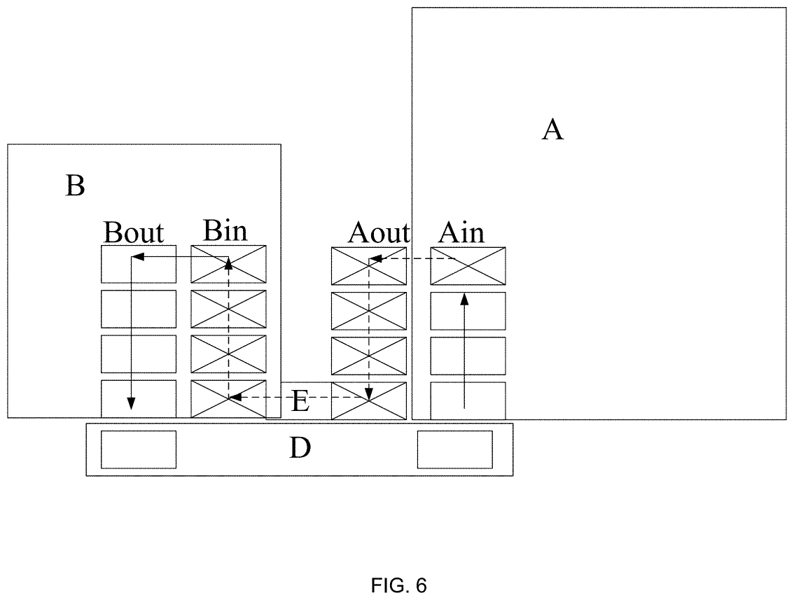

In FIG. 5, Ain and Aout are provided at a same level and Ain is located on a side of Aout, Bin and Bout are provided at a same level and Bin is located on a side of Bout, Ain and Aout are located in the smear preparation device 10, and Bin and Bout are located in the cell image analysis device 20. To recycle the first smear storage device 30 from the cell image analysis device 20, a connection mechanism D is provided between Bout and Ain and the first smear storage device 30 is transported from Bout to Ain via the connection mechanism D, and another connection mechanism E is provided between Aout and Bin and the first smear device 30 is transported from Aout to Bin via the connection mechanism E. The connection mechanisms D and E and the buffer areas may be located at a same level or different levels, which is not limited in this embodiment. Certainly, in an actual design process, a part of buffer area of Bout may be located outside the cell image analysis device 20 or a part of buffer area of Ain may be located outside the smear preparation device, so as to implement direct connection between Bout and Ain via the part of buffer area located outside. In this way, the connection mechanism D provided between Bout and Ain can be omitted. This arrangement may also be applied between Aout and Bin for connection via a part of buffer area. A difference from the transport device 40 shown in FIG. 5 is that: in the transport device shown in FIG. 6, Ain is located in the smear preparation device and Aout is located outside the smear preparation device.

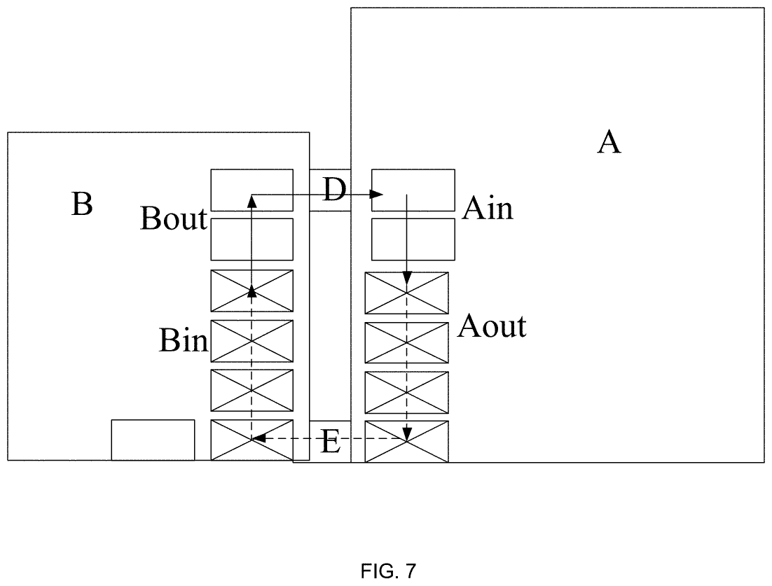

FIG. 7 shows another structure of the transport device 40 provided in this embodiment, which is different from FIG. 5 in that, although Ain and Aout are provided at a same level and are both located in the smear preparation device 10, Ain and Aout are located on a same axis and Ain is located before Aout. Bin and Bout are similar, namely, although Bin and Bout are provided at a same level and are both located in the cell image storage device 20, Bin and Bout are located on a same line and Bout is located before Bin. A connection mechanism may be provided or a part of buffer area may be located outside the smear preparation device 10, so as to connect Ain and Bout. Bin and Aout are similar, and reference may be made to the description of FIG. 5 for details.

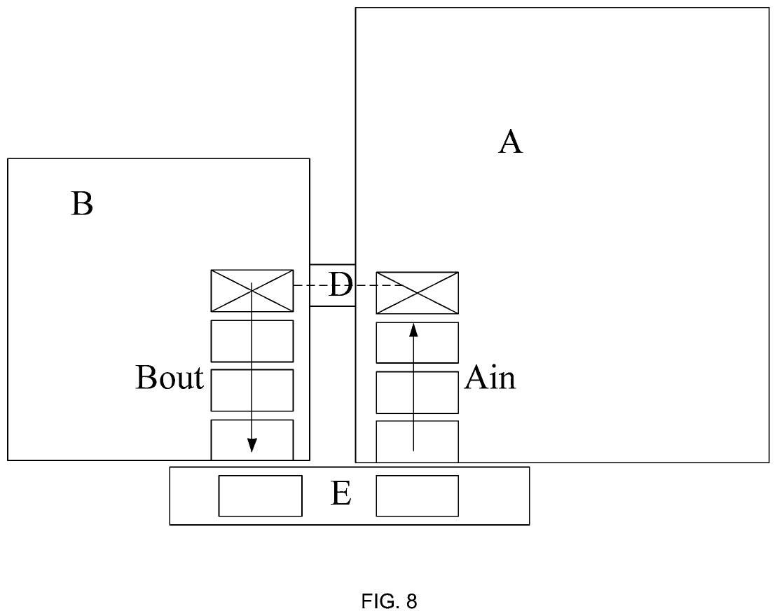

A difference from the transport device 40 shown in FIG. 7 is that: the transport device 40 shown in FIG. 8 includes only two buffer areas, namely Ain and Bout. The empty first smear storage device 30 is buffered in Ain and Bout. Each time the transport device 40 transports a first smear storage device 30 with a sample smear placed therein from the smear preparation device 10 to the cell image analysis device 20, the cell image analysis device 20 immediately processes the sample smear placed in the first smear storage device, to accelerate processing. The transport device shown in FIG. 8 is suitable when working efficiency of the smear preparation device 10 is similar to that of the cell image analysis device 20.

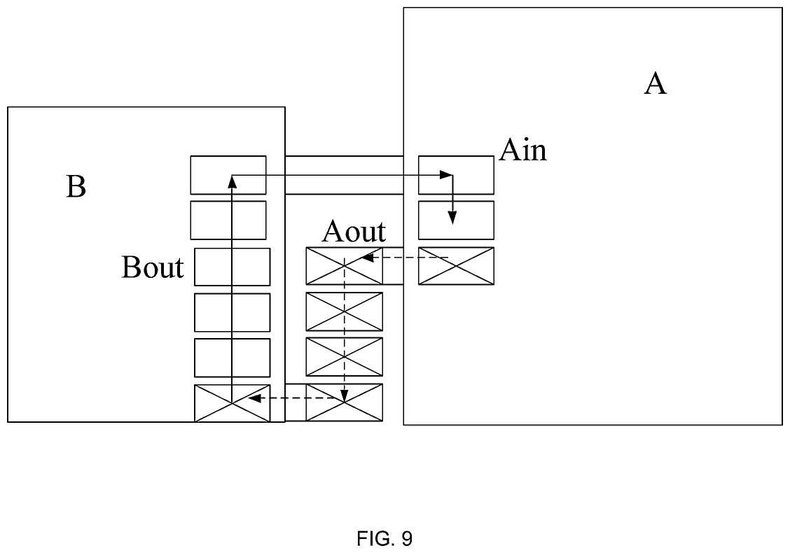

The transport device 40 shown in FIG. 9 includes three buffer areas, namely Ain, Aout, and Bout. Ain is located in the smear preparation device 10, Aout is located outside the smear preparation device 10, and Bout is located in the cell image analysis device. This transport device is suitable when the work efficiency of the cell image analysis device 20 is lower than that of the smear preparation device 10. For connection between Ain and Bout, reference may be made to the foregoing description.

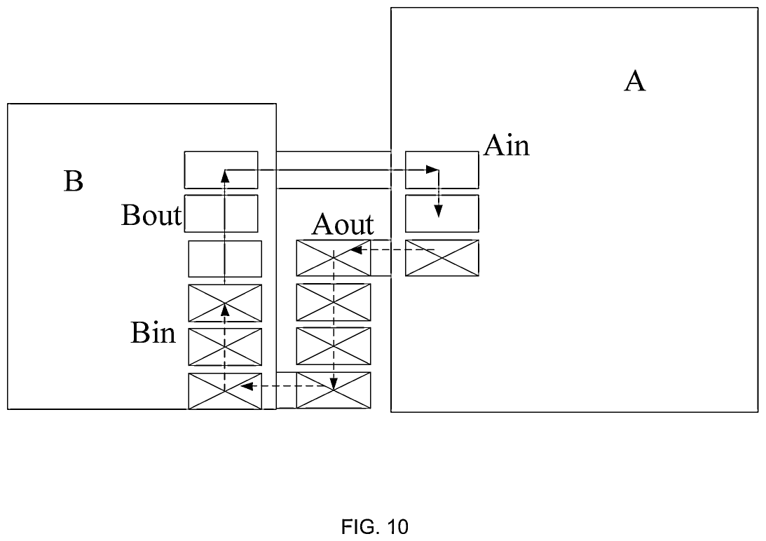

The transport device 40 shown in FIG. 10 includes four buffer areas. Arrangements of Ain and Aout in the four buffer areas are the same as those of Ain and Aout in FIG. 9, and arrangements of Bin and Bout are the same as those of Bin and Bout in FIG. 7.

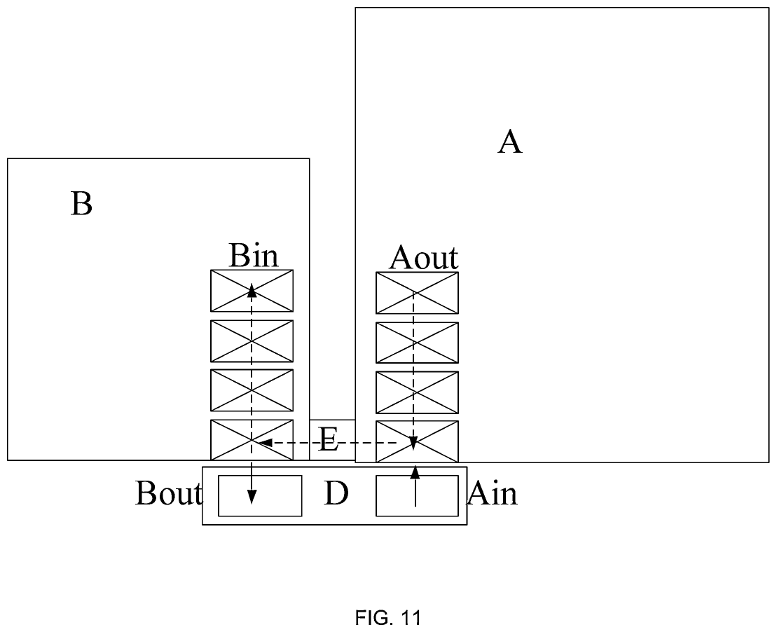

In each transport device shown in FIG. 5 to FIG. 10, the buffer areas included in the transport device 40 are all provided at a same level. The transport device 40 shown in FIG. 11 includes four buffer areas, but the four buffer areas are arranged one above another, wherein Aout is located above Ain, Bin is located above Bout, Ain and Aout are located in the smear preparation device 10, and Bin and Bout are located in the cell image analysis device 20. For connection between Ain and Bout and connection between Aout and Bin, reference may be made to the foregoing description.

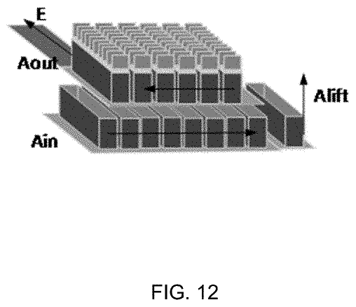

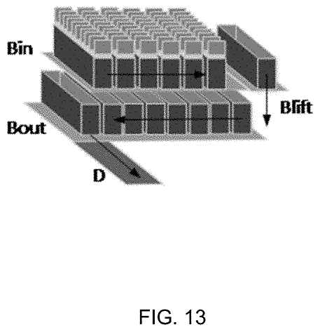

Compared with the foregoing transport devices 40, the transport device 40 shown in FIG. 11 further has a function of transporting the first smear storage device between Ain and Aout and transporting the first smear storage device between Bin and Bout. A transport process may be shown in FIG. 12 and FIG. 13, wherein FIG. 12 shows transport of the empty first smear storage device 30 from Ain to Aout, and FIG. 13 shows transport of the first smear storage device, from which all sample smears are retrieved, from Bin to Bout. To transport the empty first smear storage device 30 from Ain to Aout, the transport device includes a mechanism that has a lifting function and that is provided in the smear preparation device 10, which mechanism transports the first smear storage device. Similarly, to transport the first smear storage device, from which all sample smears are retrieved, from Bin to Bout, the transport device 40 includes a mechanism that has a lifting function and that is provided in the cell image analysis device 20, which mechanism transports the first smear storage device 30.

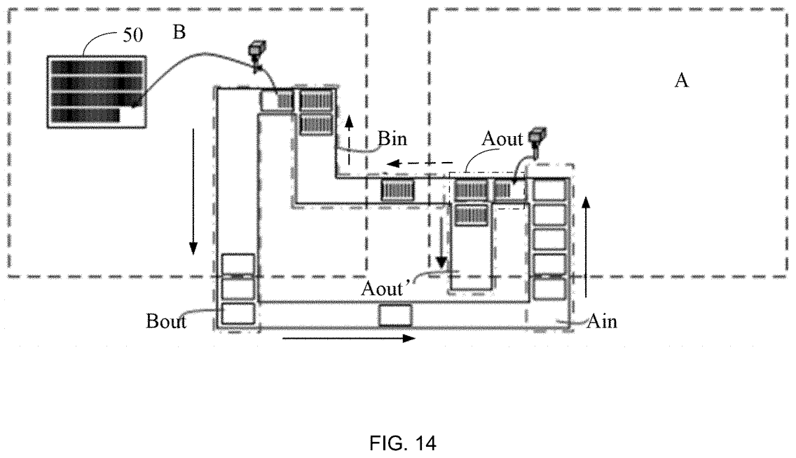

For at least one of the first input buffer area and the second output buffer area, a user may manually place an empty first smear storage device 30 in at least one of the two buffer areas. Empty first smear storage devices 30 placed in the at least one of the two buffer areas are sequentially arranged. The so-called sequential arrangement means that the placed first smear storage devices 30 are consecutively provided and there is no space between the first smear storage devices for storing an additional first smear storage device 30. The sample smear prepared by the smear preparation device 10 includes a sample smear that does not need to be imaged and analyzed. For this type of sample smear, the transport device 40 may transport the first smear storage device placed with the sample smear that does not need to be imaged and analyzed, away from the smear preparation device 10. Correspondingly, the transport device may further include another output buffer area for buffering the first smear storage device 30 placed with the sample smear that does not need to be imaged and analyzed. As shown in FIG. 14, Aout′ in FIG. 14 represents an output buffer area for buffering the first smear storage device 30 placed with the sample smear that does not need to be imaged and analyzed.

Compared with the foregoing sample processing system, the sample processing system provided in this embodiment may further include a control device configured to: when the first input buffer area has free space and the second output buffer area is placed with the first smear storage device 30, instruct the transport device 40 to transport the first smear storage device 30 from the second output buffer area to the first input buffer area. In addition, the control device is further configured to: when a buffer space of the first output buffer area is smaller than a preset buffer space (it means that no first smear storage device can be stored any more, and a value of the preset buffer space is not limited), instruct the smear preparation device 10 to stop working, and/or when a buffer space of the second output buffer area is full, instruct the cell image analysis device 20 to stop working, and when there is no first smear storage device 30 in the second input buffer area, instruct the cell image analysis device 20 to stop working.

During preparation of the sample smear by the smear preparation device 10, the smear preparation device 10 soaks and stains a plurality of glass slides simultaneously after smearing. The glass slides need to be placed into the first smear storage device 30 in time after staining, otherwise, an excessively long staining time affects the staining effect. Therefore, a number of sample smears that may be stored by the empty first smear storage device 30 in the first input buffer area needs to be greater than a number of sample smears currently prepared by the smear preparation device 10, to ensure that the prepared sample smears are stored in time. Based on this, the control device of this embodiment is further configured to: if the number of sample smears that may be stored by the first smear storage device 30 in the first input buffer area is less than the number of sample smears currently prepared by the smear preparation device 10, instruct the smear preparation device 10 to stop working.

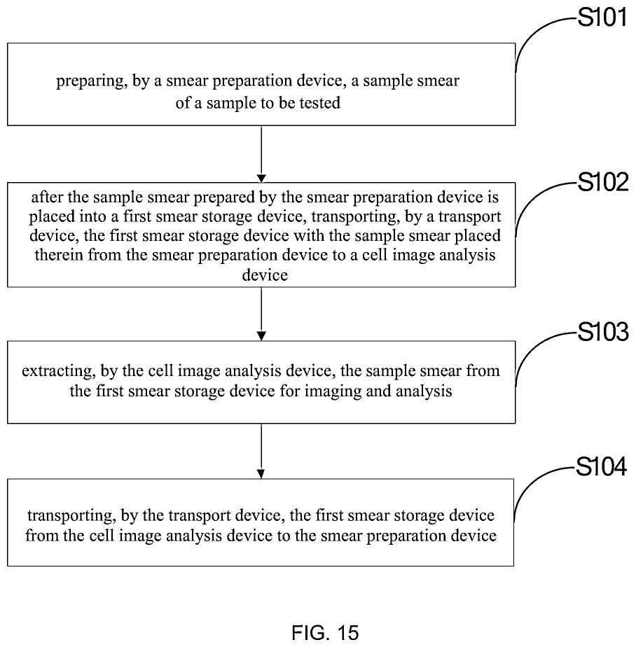

FIG. 15 shows an optional process of a sample processing method according to an embodiment of the disclosure. The method may include the following steps:

S101: preparing, by a smear preparation device, a sample smear of a sample to be tested.

S102: After the sample smear prepared by the smear preparation device is placed into a first smear storage device, transporting, by a transport device, the first smear storage device with the sample smear placed therein from the smear preparation device to a cell image analysis device. For description of the transport device, reference may be made to the foregoing system embodiments.

S103: extracting, by the cell image analysis device, the sample smear from the first smear storage device for imaging and analysis.

S104: transporting, by the transport device, the first smear storage device from the cell image analysis device to the smear preparation device.

In this embodiment, the transport device may transport the first smear storage device from the cell image analysis device to the smear preparation device on the following occasion: after the cell image analysis device retrieves all sample smears in the first smear storage device, the first smear storage device is transported from the cell image analysis device to the smear preparation device by the transport device, that is, after all the sample smears in the first smear storage device are extracted to the cell image analysis device, the first smear storage device is recycled. In this case, whether the cell image analysis device completes imaging of the sample smears is not limited in this embodiment. For example, the transporting, by the transport device, the first smear storage device from the cell image analysis device to the smear preparation device includes: detecting in real time whether all sample smears to be tested in the first smear storage device are taken away; and when it is detected that all the smears in the first smear storage device are taken away, controlling the transport device to transport the first smear storage device from the cell image analysis device to the smear preparation device, to continue to place a sample smear prepared by the smear preparation device in the first smear storage device.

During transporting the first smear storage device by the transport device, the first smear storage device transported by the transport device to the cell image analysis device is placed with a sample smear, but for the first smear storage device transported from the cell image analysis device to the smear preparation device, the following two cases may be included.

One case is as follows: the first smear storage device transported from the cell image analysis device to the smear preparation device is placed with a sample smear that has been imaged by the cell image analysis device. In this case of transporting the first smear storage device to the smear preparation device, a user is required to manually take away the sample smear from the first smear storage device.

Another case is as follows: the transport device transports the empty first smear storage device (that is, no sample smear is placed therein) from the cell image analysis device to the smear preparation device, so that a user is not required to manually take away the sample smear. The empty first smear storage device may be further configured to place a sample smear prepared by the smear preparation device. In addition, during the sample smear passing through the cell image analysis device, the cell image analysis device usually smears lens oil on the surface of the sample smear. If the sample smear whose surface is smeared with lens oil is returned to the first smear storage device, the first smear storage device will be contaminated. During repeated usage of the first smear storage device, the user needs to manually clean the first smear storage device. However, if an empty first smear storage device is transported to the smear preparation device after passing through the cell image analysis device, it indicates that the sample smear passing through the cell image analysis device is not returned to the first smear storage device and the first smear storage device will not be contaminated by the sample smear. Therefore, the user does not need to manually clean the first smear storage device.

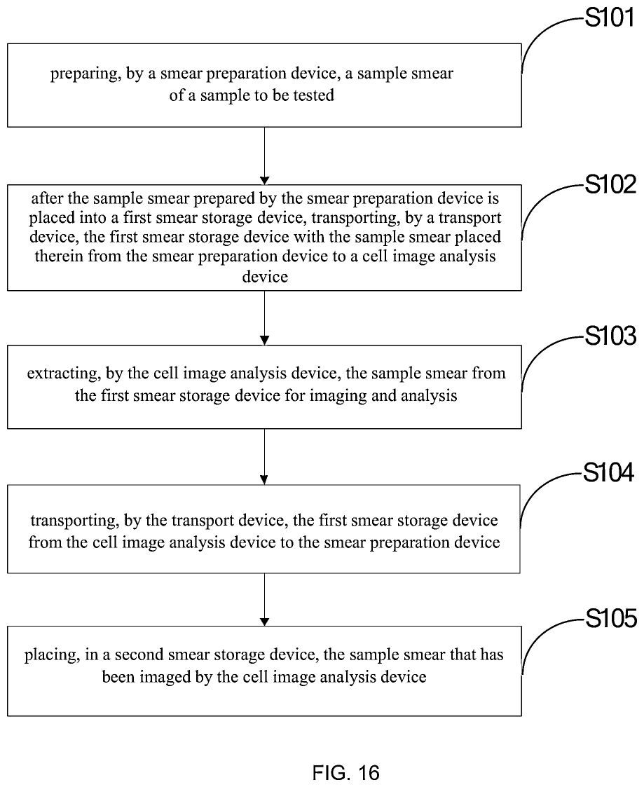

Correspondingly, the sample processing method provided in this embodiment may further include step S105: placing, in a second smear storage device, the sample smear that has been imaged by the cell image analysis device, as shown in FIG. 16. In this way, the second smear storage device recycles sample smears, thereby reducing workload of organizing processed sample smears by the user and also avoiding contamination of the first smear storage device. The structure of the second smear storage device is not limited in this embodiment. For example, the second smear storage device may be a smear basket. Because a storage space of the second smear storage device is limited, when the storage space of the second smear storage device is full, for example, an entire area for placing sample smears is fully placed with sample smears, an empty second smear storage device may be used. Certainly, the sample smears may be alternatively removed from the second smear storage device, for example, the user manually removes the sample smears from the second smear storage device, or a gripping mechanism may be used to remove the sample smears from the second smear storage device.

In this embodiment, manners of placing, in a second smear storage device, the sample smear that has been imaged by the cell image analysis device may include, but are not limited to, the following manners.

One manner is as follows: placing, in the second smear storage device by a transport component in the cell image analysis device, the sample smear that has been imaged. For example, the transport component may be a gripping mechanism, and the gripping mechanism transports the sample smear that has been imaged to the second smear storage device. In this way, the sample smear may be recycled by the cell image analysis device itself, so that the structure of the cell image analysis device does not need to be changed and the structure of the transport device can be simplified. Herein, for example, the transport component places the sample smear that has been imaged into the second smear storage device through a first transport path, and the transport device transports the first smear storage device from the cell image analysis device to the smear preparation device through a second transport path. The first transport path and the second transport path are different from each other and are not overlapped with each other except in the cell image analysis device.

Another manner is as follows: transporting the sample smear that has been imaged to the second smear storage device through a second transport branch of the transport device, wherein a first transport branch of the transport device is configured to cyclically transport the first smear storage device between the smear preparation device and the cell image analysis device, so that entire transport of the sample smear is completed by the transport device 40. In this way, the cell image analysis device 20 does not need to recycle the sample smear, so that the cell image analysis device may focus on imaging and analysis. Herein, the first transport branch and the second transport branch are different from each other and are not overlapped with each other except in the cell image analysis device.

According to the above technical solutions, after the sample smear prepared by the smear preparation device is placed into the first smear storage device, the transport device transports the first smear storage device with the sample smear placed therein from the smear preparation device to the cell image analysis device. Besides, the transport device transports the first smear storage device from the cell image analysis device to the smear preparation device. In this way, the transport device automatically and cyclically transports the first smear storage device between the smear preparation device and the cell image analysis device, and the first smear storage device is automatically recycled in the smear preparation device. Therefore, a user is no longer required to manually recycle the first smear storage device, and unnecessary human-computer interaction operations are reduced, thereby reducing workload of the user.

The sample processing method provided in this embodiment may further include: transporting, by the transport device, a first smear storage device for placing a sample smear to the smear preparation device. It should be noted that said first smear storage device herein is not the first smear storage device recycled from the cell image analysis device, and instead is an empty first smear storage device transported by the transport device to the smear preparation device for the first time. These first smear storage devices are continuously and cyclically transported between the smear preparation device and the cell image analysis device by the transport device, to recycle the first smear storage devices. Certainly, the first smear storage device may be damaged during usage, and the damaged first smear storage device may be manually removed by the user. Alternatively, other steps are added to the sample processing method. For example, an imaging device images the first smear storage device, to identify whether the first smear storage device is damaged based on an image recognition algorithm, and if yes, the transport device is instructed to remove the damaged first smear storage device, so that the damaged first smear storage device is no longer used. Alternatively, in the sample processing method, a preset usage time of the first smear storage device is set, and if an actual usage time is longer than the preset usage time, the transport device removes the first smear storage device, so that the first smear storage device is no longer used.

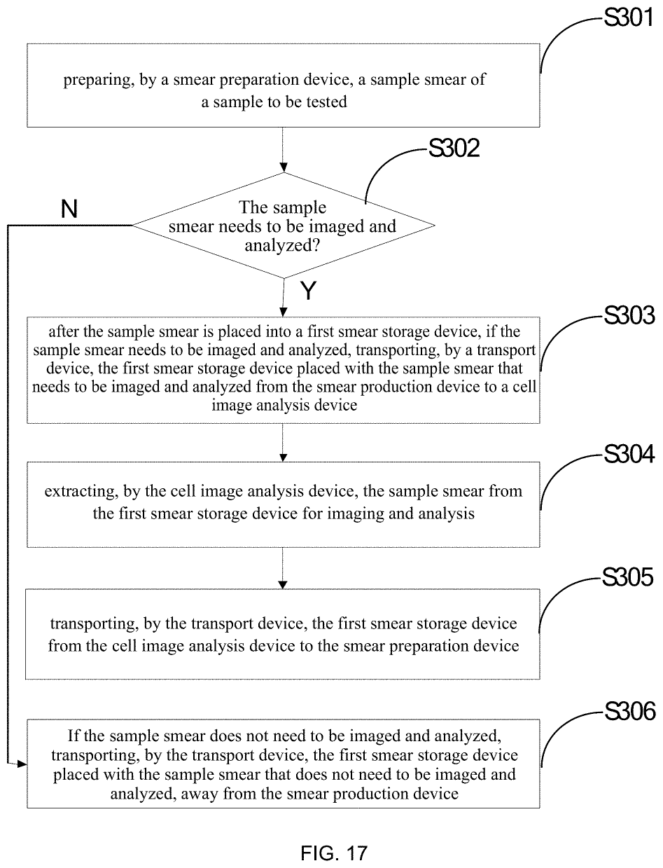

The sample smear prepared by the smear preparation device includes at least two types: a sample smear that needs to be imaged and analyzed and a sample smear that does not need to be imaged and analyzed, and the transporting, by a the transport device, the first smear storage device with the sample smear placed therein from the smear preparation device to a cell image analysis device, includes: if the sample smear needs to be imaged and analyzed, transporting, from the smear preparation device to the cell image analysis device by using the transport device, the first smear storage device placed with the sample smear that needs to be imaged and analyzed. If the sample smear does not need to be imaged and analyzed, an optional flow of the sample processing method provided in this embodiment is shown in FIG. 17, and may include the following steps:

S301: preparing, by a smear preparation device, a sample smear of a sample to be tested.

S302: determining whether the sample smear needs to be imaged and analyzed, and if yes, performing step S303, and if not, performing step S306.

S303: After the sample smear prepared by the smear preparation device is placed into a first smear storage device, if the sample smear needs to be imaged and analyzed, transporting, by a transport device, the first smear storage device placed with the sample smear that needs to be imaged and analyzed from the smear preparation device to a cell image analysis device.

S304: extracting, by the cell image analysis device, the sample smear from the first smear storage device for imaging and analysis.

S305: transporting, by the transport device, the first smear storage device from the cell image analysis device to the smear preparation device.

S306: If the sample smear does not need to be imaged and analyzed, transporting, by the transport device, the first smear storage device placed with the sample smear that does not need to be imaged and analyzed, away from the smear preparation device.

When there are a sample smear that needs to be imaged and analyzed and a sample smear that does not need to be imaged and analyzed, the sample processing method provided in this embodiment may further include: controlling the sample smear that needs to be imaged and analyzed and the sample smear that does not need to be imaged and analyzed to be respectively placed in different first smear storage devices, so as to store the sample smears differently. In this way, only all sample smears that need to be imaged and analyzed can reach the cell image analysis device, and the sample smears that do not need to be imaged and analyzed are prevented from reaching the cell image analysis device. Compared with transport of all sample smears to the cell image analysis device, the sample smears that needs to be imaged and analyzed can reach the cell image analysis device more quickly, and analysis efficiency of the sample smear is improved.

For on the foregoing sample processing method, the sample processing method provided in this embodiment may further include: buffering the first smear storage device in a buffer area of the transport device, to avoid that the smear preparation device and the cell image analysis device cannot operate the first smear storage device in time.

In this embodiment, the buffering the first smear storage device in the buffer area of the transport device includes at least one of the followings:

buffering, in a first input buffer area of the transport device, the empty first smear storage device that needs to be transported to the smear preparation device;

buffering, in a first output buffer area of the transport device, the first smear storage device placed with the sample smear, that is transported out of the smear preparation device;

buffering, in a second input buffer area of the transport device, the first smear storage device placed with the sample smear, that needs to be transported to the cell image analysis device; and buffering, in a second output buffer area of the transport device, the empty first smear storage device that needs to be transported to the first input buffer area.

The first smear storage device is effectively used by using the first input buffer area, the first output buffer area, the second input buffer area, and the second output buffer area. For description of these four buffer areas, reference may be made to the foregoing system embodiments. If the first output buffer area is located above the first input buffer area, the sample processing method provided in this embodiment may further include: transporting, by the transport device, the empty first smear storage device buffered in the first input buffer area to the first output buffer area, so as to receive the sample smear prepared by the smear preparation device;

and/or

if the second output buffer area is located below the second input buffer area, the sample processing method provided in this embodiment may further include: transporting, by the transport device, the empty first smear storage device in the second input buffer area from the second input buffer area to the second output buffer area, wherein the sample smear in the empty first smear storage device in the second input buffer area is retrieved by the cell image analysis device.

In this embodiment, in the sample processing method, when the transport device transports the first smear storage device to the first input buffer area may be further controlled. For example, the sample processing method may further include: when the first input buffer area has free space and the second output buffer area is placed with the empty first smear storage device, instructing the transport device to transport the first smear storage device from the second output buffer area to the first input buffer area.

In this embodiment, in the sample processing method, working of the smear preparation device and/or the cell image analysis device may be further controlled. For example, the sample processing method further includes the following steps:

when a buffer space of the first output buffer area is smaller than a preset buffer space, instructing the smear preparation device to suspend working;

and/or

when a buffer space of the second output buffer area is full, instructing the cell image analysis device to suspend working;

and/or

if a number of sample smears that may be stored by the empty first smear storage device in the first input buffer area is less than a number of sample smears currently prepared by the smear preparation device, instructing the smear preparation device to stop working.

Corresponding to the foregoing sample processing method, an optional structure of a control system provided in an embodiment of the disclosure may include a transport device and a control device. The control device is connected to the transport device and is configured to:

control the transport device to transport a first smear storage device with a sample smear placed therein from a smear preparation device to a cell image analysis device, wherein the sample smear in the first smear storage device is prepared by the smear preparation device; and control the transport device to transport the first smear storage device from the cell image analysis device to the smear preparation device. For a process of controlling the transport device by the control device, references may be made to the above method embodiments, which will not be described in this embodiment.

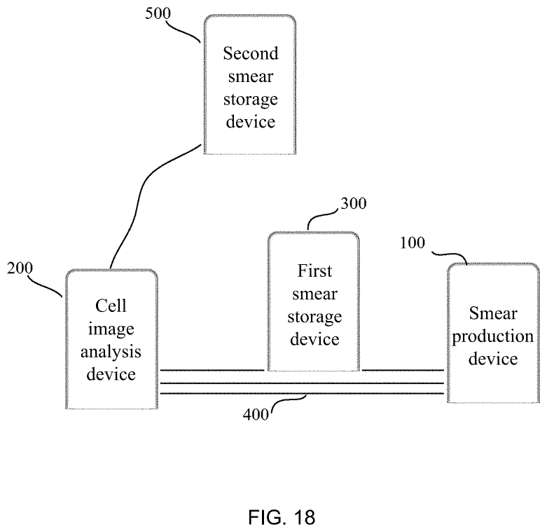

FIG. 18 shows an optional structure of another sample processing system according to an embodiment of the disclosure. The sample processing system may include a smear preparation device 100, a cell image analysis device 200, a first smear storage device 300, a transport device 400 and a second smear storage device 500.

The smear preparation device 100 is configured to prepare a sample smear of a sample to be tested.

The cell image analysis device 200 is configured to image and analyze the sample smear prepared by the smear preparation device.

The first smear storage device 300 is configured to place the sample smear prepared by the smear preparation device.

The transport device 400 is configured to: after the sample smear prepared by the smear preparation device is placed into the first smear storage device, transport the first smear storage device with the sample smear placed therein from the smear preparation device to the cell image analysis device.

The second smear storage device 500 is configured to recycle the sample smear that has been imaged and analyzed by the cell image analysis device.

A difference from the sample processing system shown in FIG. 1 is that: in the sample processing system shown in FIG. 18, the transport device 400 is responsible for transporting the first smear storage device 300 with the sample smear placed therein from the smear preparation device 100 to the cell image analysis device 200, but does not transport the first smear storage device 300 from the cell image analysis device 200 to the smear preparation device 100. However, unnecessary human-computer interaction operations and workload of a user are also reduced to some extent. Besides, the second smear storage device 500 is added to the sample processing system shown in FIG. 18, so that the second smear storage device 500 recycles sample smears, thereby reducing workload of organizing processed sample smears by the user and also avoiding contamination of the first smear storage device 300. The structure of the second smear storage device 500 is not limited in this embodiment. For example, the second smear storage device 500 may be a smear basket. Because a storage space of the second smear storage device 500 is limited, when the storage space of the second smear storage device 500 is full, for example, an entire area for placing sample smears is fully placed with sample smears, an empty second smear storage device 500 may be used. Certainly, the sample smears may be alternatively removed from the second smear storage device 500, for example, a user manually removes the sample smears from the second smear storage device 500, or a gripping mechanism is added to the sample processing system, so that the gripping mechanism removes the sample smears from the second smear storage device 500.

In this embodiment, the second smear storage device 500 may recycle the sample smear that has been imaged by the cell image analysis device 200 by the following manners, but the disclosure is not limited to these manners.

One manner is as follows: The cell image analysis device 200 is further configured to: transport the sample smear that has been imaged to the second smear storage device by using a transport component of the cell image analysis device. For example, the transport component is configured to transport the sample smear that has been imaged to the second smear storage device through a first transport path, and the transport device is configured to transport the first smear storage device from the smear preparation device to the cell image analysis device through a second transport path. The first transport path and the second transport path are different from each other and are not overlapped with each other.

Another manner is as follows: The transport device includes a first transport branch and a second transport branch, the first transport branch is configured to cyclically transport the first smear storage device between the smear preparation device and the cell image analysis device, and the second transport branch is configured to transport the sample smear that has been imaged to the second smear storage device.

According to the foregoing technical solution, the transport device 400 transports the first smear storage device 300 with the sample smear placed therein from the smear preparation device 100 to the cell image analysis device 200. In this way, unnecessary human-computer interaction operations and workload of a user are also reduced to some extent. In addition, the second smear storage device 500 recycles sample smears, thereby reducing workload of organizing processed sample smears by the user and also avoiding contamination of the first smear storage device 300.

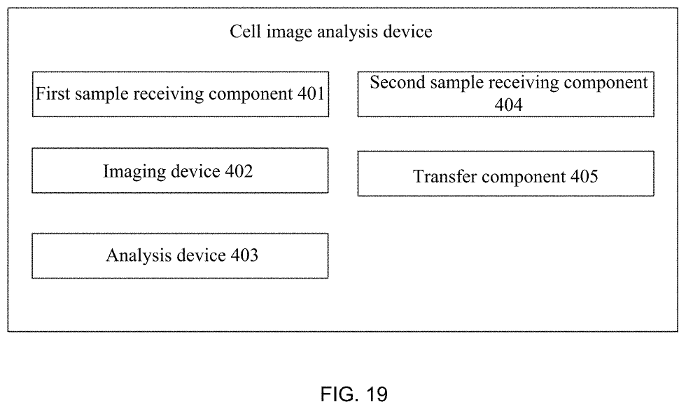

FIG. 19 shows an optional structure of a cell image analysis device according to an embodiment of the disclosure. The cell image analysis device may include a first sample receiving component 401, an imaging device 402, an analysis device 403, a second sample receiving component 404, and a transfer component 405.

The first sample receiving component 401 is configured to receive a sample smear transported from a smear preparation device.

The imaging device 402 is configured to image the sample smear to obtain cell images.

The analysis device 403 is configured to analyze the cell images.

The second sample receiving component 404 is configured to receive the sample smear that has been imaged by the imaging device.

The transfer component 405 is located between the first sample receiving component and the imaging device and between the imaging device and the second sample receiving component, and is configured to provide the sample smear in the first sample receiving component to the imaging device and transport the sample smear that has been imaged by the imaging device to the second sample receiving component.

Structures of the first sample receiving component 401 and the second sample receiving component 404 are not limited in this embodiment, for example, the first sample receiving component 401 and the second sample receiving component 404 may be smear baskets. The first sample receiving component 401 receives sample smears transported from the smear preparation device for usage by the imaging device 402, and the second sample receiving component 404 recycles sample smears imaged by the imaging device, so as to store sample smears that do not pass through the imaging device and sample smears that pass through the imaging device differently, and to avoid contaminating the first sample receiving component and consequently avoid contaminating the sample smear received from the smear preparation device.

The transfer component 405 may be a component with a gripping function, such as a manipulator, and is not limited in this embodiment.

An embodiment of the disclosure further provides a storage medium storing executable instructions and configured to cause a processor to execute the executable instructions to implement the foregoing sample processing method.

Those skilled in the art should understand that the embodiments of the disclosure may be provided as a method, a system, or a computer program product. Therefore, the embodiments of the disclosure may take the form of hardware embodiments, software embodiments, or embodiments with a combination of software and hardware. Moreover, the embodiments of the disclosure may take the form of a computer program product that is implemented on one or more computer-usable storage media (including a disk memory and an optical memory, etc.) that include computer-usable program code.

The embodiments of the disclosure are described with reference to flowcharts and/or block diagrams of the methods, apparatuses (systems), and computer program products according to the embodiments of the disclosure. It should be understood that each procedure and/or block in the flowcharts and/or block diagrams, and combinations of the procedures and/or blocks in the flowcharts and/or block diagrams may be implemented by computer program operations. These computer program operations may be provided to a processor of a general-purpose computer, a special-purpose computer, an embedded processor or other programmable data processing apparatuses to create a machine, such that the operations executed by the processor of the computer or other programmable data processing apparatuses create a device for implementing functions specified in one or more procedures in the flowcharts and/or one or more blocks in the block diagrams.

These computer program operations may also be stored in a computer-readable memory that may direct the computer or other programmable data processing apparatus to operate in a specific manner, such that the operations stored in the computer-readable memory create an article of manufacture including an operation device, and the operation device implements the functions specified in one or more procedures in the flowcharts and/or one or more blocks in the block diagrams.

These computer program operations may also be loaded onto the computer or other programmable data processing apparatuses to enable a series of operation steps to be executed on the computer or other programmable apparatuses to perform computer-implemented processing, such that the operations executed on the computer or other programmable apparatuses provide steps for implementing the functions specified in one or more procedures in the flowcharts and/or one or more blocks in the block diagrams.

The foregoing descriptions are merely the preferred embodiments of the disclosure, and are not intended to limit the scope of protection of the disclosure. Any modifications, equivalent substitutions and improvements made within the spirit and principles of the disclosure shall be included within the scope of protection of the disclosure.

What is claimed is:

1. A sample processing system, comprising:
a smear preparation device configured to prepare a sample smear of a sample to be tested;
a cell image analysis device configured to image and analyze the sample smear prepared by the smear preparation device;
a first smear storage device configured to place the sample smear prepared by the smear preparation device; and
a transport device connected to the smear preparation device and the cell image analysis device and configured to: after the sample smear prepared by the smear preparation device is placed into the first smear storage device, transport the first smear storage device with the sample smear placed therein from the smear preparation device to the cell image analysis device; and transport the first smear storage device from the cell image analysis device to the smear preparation device.

2. The sample processing system according to claim 1, wherein the transport device is further configured to: after the cell image analysis device retrieves all sample smears from the first smear storage device, transport the empty first smear storage device from the cell image analysis device to the smear preparation device.

3. The sample processing system according to claim 2, wherein the empty first smear storage device, which is transported from the cell image analysis device to the smear preparation device by the transport device, is further configured to place a sample smear prepared by the smear preparation device.

4. The sample processing system according to claim 2, further comprising a control device configured to: according to information that all sample smears in the first smear storage device are taken away, automatically control the transport device to transport the empty first smear storage device from the cell image analysis device to the smear preparation device.

5. The sample processing system according to claim 1, further comprising:
a second smear storage device configured to recycle the sample smear that has been imaged by the cell image analysis device.

6. The sample processing system according to claim 5, wherein the cell image analysis device is further configured to transport the sample smear that has been imaged to the second smear storage device by using a transport component of the cell image analysis device.

7. The sample processing system according to claim 6, wherein a first transport path for transporting the sample smear that has been imaged to the second smear storage device by the transport component and a second transport path for transporting the first smear storage device between the smear preparation device and the cell image analysis device by the transport device are different from each other and are not overlapped with each other.

8. The sample processing system according to claim 6, wherein the transport component is a gripping mechanism.

9. The sample processing system according to claim 5, wherein the transport device comprises a first transport branch and a second transport branch, wherein the first transport branch is configured to cyclically transport the first smear storage device between the smear preparation device and the cell image analysis device, and the second transport branch is configured to transport the sample smear that has been imaged to the second smear storage device.

10. The sample processing system according to claim 9, wherein the first transport branch and the second transport branch are different from each other and are not overlapped with each other.

11. The sample processing system according to claim 1, wherein the smear preparation device is further configured to: if the sample smear needs to be imaged and analyzed, transport, from the smear preparation device to the cell image analysis device by using the transport device, the first smear storage device placed with the sample smear that needs to be imaged and analyzed.

12. The sample processing system according to claim 11, wherein the smear preparation device is further configured to control the sample smear that needs to be imaged and analyzed and the sample smear that does not need to be imaged and analyzed to be respectively placed in different first smear storage devices.

13. The sample processing system according to claim 1, wherein the transport device comprises a first transport component and a second transport component, wherein:
the first transport component is configured to: after the prepared sample smear is placed into the first smear storage device by the smear preparation device, transport the first smear storage device with the sample smear placed therein from the smear preparation device to the cell image analysis device; and
the second transport component is configured to transport the empty first smear storage device from the cell image analysis device to the first transport component.

14. The sample processing system according to claim 13, wherein the first transport component and the second transport component are a same transport component; or
the first transport component and the second transport component are two conveyor belts independent of each other.

15. The sample processing system according to claim 13, wherein at least one of the first transport component and the second transport component corresponds to a buffer area, and the buffer area is configured to buffer the first smear storage device.

16. The sample processing system according to claim 1, wherein the transport device comprises at least one of a first input buffer area, a first output buffer area, a second input buffer area and a second output buffer area, wherein:
the first input buffer area is configured to buffer the empty first smear storage device that needs to be transported to the smear preparation device;
the first output buffer area is configured to buffer the first smear storage device placed with the sample smear, that is transported out of the smear preparation device;
the second input buffer area is configured to buffer the first smear storage device placed with the sample smear, that needs to be transported to the cell image analysis device; and
the second output buffer area is configured to buffer the empty first smear storage device that needs to be transported to the first input buffer area.

17. The sample processing system according to claim 16, wherein the first input buffer area and the first output buffer area are arranged one above another;
and/or the second input buffer area and the second output buffer area are arranged one above another.

18. The sample processing system according to claim 17, wherein the first output buffer area is located above the first input buffer area; and
the transport device is further configured to transport the empty first smear storage device buffered in the first input buffer area to the first output buffer area, so as to receive the sample smear prepared by the smear preparation device; and/or
the second output buffer area is located below the second input buffer area; and
the transport device is further configured to transport the empty first smear storage device in the second input buffer area from the second input buffer area to the second output buffer area, wherein the sample smear in the empty first smear storage device in the second input buffer area is retrieved by the cell image analysis device.

19. The sample processing system according to claim 17, wherein the first input buffer area and/or the first output buffer area are/is located in the smear preparation device; and/or
the second input buffer area and/or the second output buffer area are/is located in the cell image analysis device.

20. The sample processing system according to claim 16, further comprising a control device configured to: when the first input buffer area has free space and the second output buffer area is placed with the first smear storage device, instruct the transport device to transport the first smear storage device from the second output buffer area to the first input buffer area.

21. A sample processing system, comprising:
a smear preparation device configured to prepare a sample smear of a sample to be tested;
a cell image analysis device configured to image and analyze the sample smear prepared by the smear preparation device;
a first smear storage device configured to place the sample smear prepared by the smear preparation device;
a second smear storage device configured to recycle the sample smear that has been imaged and analyzed by the cell image analysis device;
a transport component configured to transport the sample smear that has been imaged to the second smear storage device through a first transport path; and
a transport device configured to: after the sample smear prepared by the smear preparation device is placed into the first smear storage device, transport the first smear storage device with the sample smear placed therein from the smear preparation device to the cell image analysis device through a second transport path;
wherein the first transport path and the second transport path are different from each other and are not overlapped with each other.

22. A cell image analysis device, comprising:
a first sample receiving component configured to receive a sample smear transported out of a smear preparation device;
an imaging device configured to image the sample smear to obtain cell images;
an analysis device configured to analyze the cell images;
a second sample receiving component configured to receive the sample smear that has been imaged by the imaging device; and
a transfer component located between the first sample receiving component and the imaging device and between the imaging device and the second sample receiving component, and configured to provide the sample smear in the first sample receiving component to the imaging device and transport the sample smear that has been imaged by the imaging device to the second sample receiving component.
